(19) United States
(12) Patent Application Publication
(10) Pub. No.: US 2024/0378206 A1
(43) Pub. Date: Nov. 14, 2024

(54) SYSTEM AND METHOD FOR ANSWERING QUESTIONS REQUIRING DATABASE QUERY RESULTS IN A LARGE LANGUAGE MODEL CHAT

(71) Applicant: Ming Jack Po, Mountain View, CA (US)

(72) Inventor: Ming Jack Po, Mountain View, CA (US)

(21) Appl. No.: 18/656,775

(22) Filed: May 7, 2024

Related U.S. Application Data
(60) Provisional application No. 63/464,868, filed on May 8, 2023.

(51) Int. Cl. G06F 16/2455; G06F 16/2452; G06F 16/248

(52) U.S. Cl. CPC G06F 16/24566; G06F 16/24522; G06F 16/248

(57) ABSTRACT

A system for responding to questions that require database queries including: a query evaluator that trained or programmed to be capable of receiving a user input question and evaluating whether the question requires one or more database queries to answer; a query generator that trained or programmed to be capable of processing the question in order to identify at least one database from a library of databases may be queried to answer the question, and to generate a query output comprising a database schema for the at least one identified database and a query to be run on the identified databases; and a large language model trained to be capable of receiving the query output from the query generator, to run the query on the identified databases, and to generate a response; and methods relating to same.

### CROSS-REFERENCE TO RELATED APPLICATIONS

This application claims the benefit of U.S. Provisional Patent Application Ser. No. 63/464,868, filed May 8, 2023, the contents of which are incorporated herein by reference.

### FIELD

The present disclosure relates generally to machine-learned models for responding to queries to large language model AI systems that require information from databases.

### BACKGROUND

The field of artificial intelligence (AI), specifically in natural language processing and generation, large language models (LLMs) have gained significant attention due to their ability to understand and generate human-like text. These models have demonstrated remarkable capabilities in various applications, such as machine translation, question-answering, and code generation. However, LLMs are limited in their ability to detect, debug, and optimize code autonomously. Similarly, when properly trained and prompted, LLMs can identify which databases may be relevant to a question Finally, the presentation of generated code or results often lacks human-readability or effective multimedia representation, which may hinder communication with users.

As the demand for AI-generated code and optimized solutions increases, there is a growing need for a more intelligent and efficient system that addresses these limitations. The present invention aims to address these limitations by introducing a system that is capable of: determining whether a user question can be answered through database queries; identifying which databases (internal or external) should be queried to answer the user question; generating a query and/or other code based on the user question; detecting errors and debugging and optimizing the generated code autonomously; running the query and/or other code to get results, and converting the results into human-readable formats, including, but not limited to exporting them into graphical/multimedia formats that can be easily interpreted by humans.

This innovative approach will significantly enhance the capabilities of LLMs, making them more useful and efficient in various applications. Furthermore, the ability to present results in easily interpretable formats will bridge the communication gap between AI-generated code and human users, allowing for better collaboration and understanding in a wide range of fields.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an embodiment, a system for responding to questions that require database queries may include: (1) a query evaluator that may be trained or programmed to be capable of receiving a user input question and evaluating whether the question requires one or more database queries to answer, (2) a query generator that may be trained or programmed to be capable of processing the question in order to identify at least one database from a library of databases may be queried to answer the question, and to generate a query output comprising a database schema for the at least one identified database and a query to be run on the identified databases, and (3) a large language model may be trained to be capable of receiving the query output from the query generator, to run the query on the identified databases, and to generate a response.

In an embodiment, a method for training a system to respond to questions that require database queries may include: providing a database library; training or programming a query evaluator to be capable of determining whether an input question can be answered using a database query; training or programming a query generator to be capable of identifying which databases in the database library are relevant to answering the input question, and generating a query to answer same; and training a large language model to be capable of receiving a query output from the query generator, the query output comprising at least one database schema for identified databases and at least one query.

In an embodiment, a method for querying an large language model may include: providing database library; presenting a question to the query evaluator, such that the query evaluator can determine whether the question can be answered by running a database query; and when the question presented can be answered by running a database query, providing the question to a query generator, to process the question and to (i) identify at least one database in the database library that can be queried to answer the question, and (ii) generate a query output; and then providing the query output to a large language model trained to receive and process the query output and to generate a proposed response to the question using results from running a query in the query output.

In an embodiment, a method for intelligent question analysis, query generation, and optimization, may include: receiving a user question; analyzing the user question to determine if the user question can be addressed using a database query; and if so, identifying which databases should be queried to answer the user question; generating a query to answer the question; running the generated query on a large language model to obtain results; and converting the results into human-readable formats or exporting them into graphical/multimedia formats that can be easily interpreted by users.

Other example aspects of the present disclosure are directed to systems, apparatus, tangible, non-transitory computer-readable media, user interfaces, memory devices, and electronic devices for conveying the results of questions that require database queries.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

The drawings set forth exemplary embodiments of the disclosed concepts, and are not intended to be limiting in any way.

FIG. 1 illustrates an embodiment of a system for answering questions that require database queries in accordance with the disclosed concepts.

FIG. 2 illustrates a flow diagram for a query evaluator in accordance with the disclosed concepts.

FIG. 3 illustrates a flow diagram for a query generator in accordance with the disclosed concepts.

FIG. 4 illustrates a flow diagram for large language model in accordance with the disclosed concepts.

FIG. 5A illustrates a flow diagram for a response control in accordance with the disclosed concepts.

FIG. 5B illustrates an alternative flow diagram for a response control in accordance with the disclosed concepts.

FIG. 6 illustrates a method for training a system to respond to questions that require database queries in accordance with the disclosed concepts.

FIG. 7 illustrates a method for using a system to respond to questions that require database queries in accordance with the disclosed concepts in accordance with the disclosed concepts.

FIG. 8 illustrates a method for intelligent question analysis, query generation, and optimization in accordance with the disclosed concepts.

### DETAILED DESCRIPTION

The following detailed description and the appended drawings describe and illustrate some embodiments for the purpose of enabling one of ordinary skill in the relevant art to make use the invention. As such, the detailed description and illustration of these embodiments are purely illustrative in nature and are in no way intended to limit the scope of the invention, or its protection, in any manner. It should also be understood that the drawings are not necessarily to scale and in certain instances details may have been omitted, which are not necessary for an understanding of the disclosure, such as details of fabrication and assembly. In the accompanying drawings, like numerals represent like components.

The term “database” as used in this application refers broadly to any collection of data that can be queried to obtain information that may be useful in answering a question, including but not limited to traditional databases, relational databases (including Oracle and SQL), spreadsheets, data tables, csv files, JSON files, and any other way of storing data known in the art or to be developed. The term “database schema” refers broadly to information that describes how data is kept in a database, as defined above, to allow a user, or in this case an LLM, to search that database to extract the information required to answer a question. The term “query” as used herein, refers broadly to any code or computer instructions that can be run in order to extract desired information from any one or more of the databases contained herein, including but not limited to traditional queries, such as structured query language (SQL) and all variants thereof, grep, scripts that parse text files and other data files, algorithms, routines and/or other computer code that can parse the information in databases, and any other methods now known or to be developed for extracting information from databases. A “query” as used herein can include several queries.

With regard to input and output, the disclosed concepts discuss the user “question” and the system generates “results” to be presented to the user in response to the question. It should be understood that the question may be posed in any suitable manner known in the art or to be developed, including but not limited to text input, human speech that is processed and by voice recognition or speech-to-text programs, or any other suitable way of receiving the question from a user now known in the art or to be developed. The results to the query may be a simple answer or may be a table or a large data set. These results, as discussed below, may be presented directly to the user as-is, may be processed to a more human readable format, such as through the generation of a graph or a multimedia file to help a user visualize the results, or exported as a dataset that the user may download or save and use accordingly.

In an embodiment, a system for responding to questions that require database queries may include: (1) a query evaluator that may be trained or programmed to be capable of receiving a user input question and evaluating whether the question requires one or more database queries to answer, (2) a query generator that may be trained or programmed to be capable of processing the question in order to identify at least one database from a library of databases may be queried to answer the question, and to generate a query output comprising a database schema for the at least one identified database and a query to be run on the identified databases, and (3) a large language model may be trained to be capable of receiving the query output from the query generator, to run the query on the identified databases, and to generate a response.

In certain embodiments, the system may further include a response controller trained or programmed to be capable of receiving the response from the large language model, evaluating whether it is an error, and in the case of an error providing the error to the query generator to be used in generating a revised query output, until it receives a non-error response. In certain embodiments, the system may further include a response controller that may be trained or programmed to be capable of receiving the response from the large language model, evaluating whether it is an error, and in the case of an error providing the error to the large language model to be used in generating a revised response, until it receives a non-error response. In certain embodiments, the query evaluator and the query generator may be an integrated model or module. In certain embodiments, the results may be displayed as a graph or multimedia file to assist the user in visualizing the data. In certain embodiments, the results may be exported as a data file that may be downloaded or saved by the user. In certain embodiments, the query evaluator, the query generator and the LLM may be integrated into a single model or module. In certain embodiments, the integrated model or module may recursively iterate through its output until the response is ready to be displayed or presented to the user. In certain embodiments, the system may further include a response control which prompts the integrated model or module to iterates through its output until the response is ready to be displayed or presented to the user.

In an embodiment, a method for training a system to respond to questions that require database queries may include: providing a database library; training or programming a query evaluator to be capable of determining whether an input question can be answered using a database query; training or programming a query generator to be capable of identifying which databases in the database library are relevant to answering the input question, and generating a query to answer same; and training a large language model to be capable of receiving a query output from the query generator, the query output comprising at least one database schema for identified databases and at least one query.

In certain embodiments, the method may further include training or programming a response controller to be capable of identifying errors in a proposed response from the large language model and sending same to the query generator to generate a revised query. In certain embodiments, the method may further include training or programming a response controller to be capable of identifying errors in a proposed response from the large language model and sending same to the large language model to use the error information to process a revised proposed response. In certain embodiments, the query evaluator and the query generator may be an integrated model or module. In certain embodiments, the results may be displayed as a graph or multimedia file to assist the user in visualizing the data. In certain embodiments, the results may be exported as a data file that may be downloaded or saved by the user. In certain embodiments, the query evaluator, the query generator and the LLM may be integrated into a single model or module. In certain embodiments, the integrated model or module may recursively iterate through its output until the response is ready to be displayed or presented to the user. In certain embodiments, the method may further include a response control which prompts the integrated model or module to iterate through its output until the response is ready to be displayed or presented to the user.

In an embodiment, a method for querying an large language model may include: providing database library; presenting a question to the query evaluator, such that the query evaluator can determine whether the question can be answered by running a database query; and when the question presented can be answered by running a database query, providing the question to a query generator, to process the question and to (i) identify at least one database in the database library that can be queried to answer the question, and (ii) generate a query output; and then providing the query output to a large language model trained to receive and process the query output and to generate a proposed response to the question using results from running a query in the query output.

In certain embodiments, the method may further include providing the proposed response from the large language model to a response controller that evaluates whether the proposed response has errors, and when the proposed response has errors sends the error to the query generator to be used to generate a revised query output. In certain embodiments, the method may further include providing the proposed response from the large language model to a response controller that evaluates whether the proposed response has errors, and when the proposed response has errors sends the error to the large language model to be used to generate a revised proposed response. In certain embodiments, the query evaluator and the query generator may be an integrated model or module. In certain embodiments, the results may be displayed as a graph or multimedia file to assist the user in visualizing the data. In certain embodiments, wherein the results may be exported as a data file that may be downloaded or saved by the user. In certain embodiments, the query evaluator, the query generator and the LLM may be integrated into a single model or module. In certain embodiments, the integrated model or module may recursively iterate through its output until the response is ready to be displayed or presented to the user. In certain embodiments, the method may further include a response control which may prompt the integrated model or module to iterate through its output until the response is ready to be displayed or presented to the user.

In an embodiment, a method for intelligent question analysis, query generation, and optimization, may include: receiving a user question; analyzing the user question to determine if the user question can be addressed using a database query; and if so, identifying which databases should be queried to answer the user question; generating a query to answer the question; running the generated query on a large language model to obtain results; and converting the results into human-readable formats or exporting them into graphical/multimedia formats that can be easily interpreted by users.

In certain embodiments, the method may further include detecting errors within the generated query autonomously; and debugging and optimizing the generated query. In certain embodiments, the analyzing the user question is performed by a small AI model may be selected from a group consisting of natural language processing models, deep learning models, and LLMs with reduced parameters. In certain embodiments, the identifying which databases should be queried to answer the user question may include evaluating whether the user question can be addressed using an internal database or if it requires external data sources. In certain embodiments, the identifying which databases should be queried to answer the user question may include keyword triggers to facilitate the identification of database queries. In certain embodiments, the method may further include integration of internal and external data sources comprising querying public datasets and/or web-based information sources. In certain embodiments, the generating a query may include generating code in various programming languages. In certain embodiments, the debugging and optimizing the generated query may involve techniques such as refactoring, code simplification, or resource optimization. In certain embodiments, the graphical/multimedia formats may include images, charts, graphs, interactive visualizations, or videos.

In certain embodiments, a system for implementing one of the foregoing the methods may include a query analysis module, a database identification module, a code generation module, and a multimedia representation module. In certain embodiments, the query analysis module, database identification module, code generation module, and multimedia representation module may communicate and interact with each other to process user queries and generate optimized code and easily interpretable results.

In certain embdoiments, a non-transitory, computer readable medium containing instructions that when executed by a processor perform any of the foregoing methods or systems.

The embodiments discussed in this disclosure are generally directed to systems where users interacts with a LLM to ask questions, some of which may implicate or be answerable through queries run on databases in a database library that the system has or can access. For example, a user may ask for average sales of a particular store in towns of above-average population on days when the temperature exceeds 50 degrees fahrenheit (10 degrees Celsius). If the system has access to a census information database (to determine whether a town is of above-average population), a national weather information database (to determine which towns were above 50 degrees fahrenheit on which days) and a sales information database for that particular store, then queries can be constructed to find and aggregate this data. Systems in accordance with the disclosed concepts may be application or industry specific, having a limited scope of databases to be queried, or may be generalized, having a broad scope of databases and information, such as a chat-bot with access to the internet.

The examples below describe the use of databases and queries to obtain information requested by users. These examples are intended to be exemplary, not limiting. Persons of skill in the art will understand that the disclosed concepts can be practiced with any type of data collection and any known way of interacting with and extracting information from such data collections.

The machine-learned models described herein can be trained using suitable training data, such as for instance, a global (or application specific) set of questions paired with a flag indicating whether such questions can be answered with a database query, and an appropriate query and database schema that can be used to answer same. More particularly, a training computing system can train the component modules of the disclosed concepts using a training dataset that includes a number of questions and corresponding query/schema pairings.

The systems and methods described herein may be implemented to run on computing systems of various different types and power. Such systems may be centralized, operating on a single server with access points, or may be distributed across multiple computing systems and servers. Such systems may have generic components, such as CPUs, GPUs, memory, hard drives, keyboards, microphones, speakers, touch screens, etc.; or such systems may have specialized hardware, such as ASICs, AI, FPGAs, etc. Persons of skill in the art will recognize that the scope, content and desired capabilities for an implementation will determine the resources and equipment needed to implement such systems.

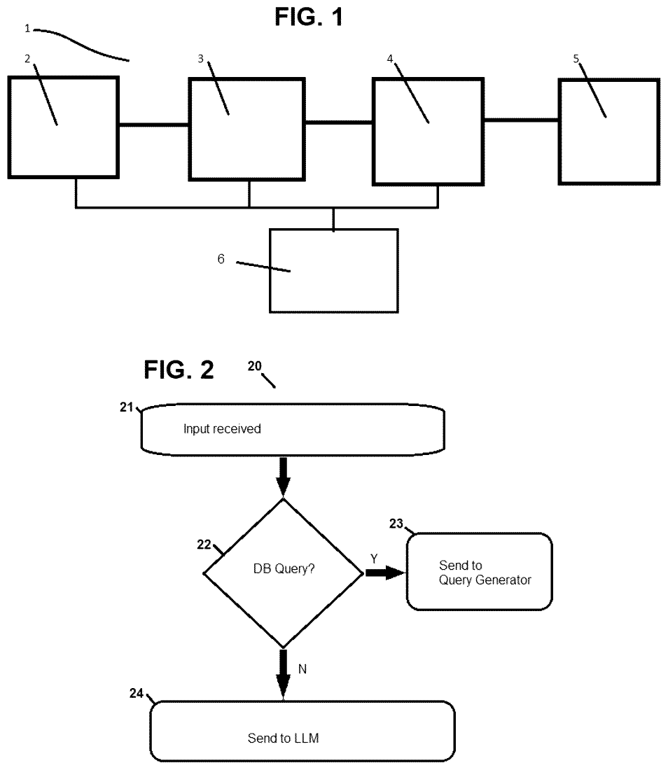

FIG. 1 illustrates an exemplary embodiment of a system 1 capable of evaluating whether a question asked by a user is the type of question that can answered with references to the results of database queries, generating a query including relevant database information, providing that query to an LLM, and revising and reiterating the query to the LLM until a suitable response is found, and publishing the response to the user. The system 1 may include a query evaluator 2 and a query generator 3, a LLM 5, a response controller 5 and a database library 6. When a user is interacting with the LLM 5, and asks it a question, the query evaluator 2 may receive the question asked by the user, and evaluate the question to see if it is of the type of questions that can be answered by a query to a database, or not. If so, the query evaluator passes the question to the query generator 3, and if not the question will be passed to the LLM for direct response to a user. The query evaluator 2 may be an artificial intelligence deep-learning model module, such as neural network, that has been trained for natural language processing (NLP) and on the databases that the system 1 has access to and on evaluating questions to determine if the question that is asked implicates the fields that are contained in the databases of the database library 6. More particularly, the neural networks (e.g. deep neural networks) can be recurrent neural networks, such as long short-term memory (LSTM) neural networks, gated recurrent unit (GRU) neural networks, or other forms of neural networks. Other suitable query evaluators, including other AI models and programmatic, non-AI models now known in the art or to be developed may be used for the query evaluator 2. Training for the query evaluator 2, and for the other AI systems disclosed herein, may be done through supervised learning, unsupervised learning, reinforcement learning, a combination of these methodologies, or by other methodologies now known or to-be developed. Back propagation, difference-target propagation, Hilbert-Schmidt Independence Criterion Bottleneck, and other learning algorithms now known or to be developed may also be used during the training of the AI systems. Part of the training for the query evaluator may include training on key words, or on the identification of key words in question, that may trigger a determination that a question can be answered through running a database query.

The query generator 3 may receive the user's question from the query evaluator 2, and use it to generate a query that can answer the user's question. When a query is passed by the query evaluator 2 to the query generator 3, the query generator 3 must identify which database schema for the databases in the database library 6 are required to answer the question, and generate a query for same. The query generator 3 may then pass the database schema and the query to the LLM 4 for evaluation and a response. The query generator 3 may be another AI deep-learning model, such as an LLM, other NLP, or other neural network. As discussed above, any suitable model or program may be used for the query generator, including AI and non-AI solutions. When AI models are used, the query generator may be trained using any of the methodologies and algorithms described above to process natural language, identify relevant database and database schema and generate queries to obtain the information requested in the question. Part of the training for the query generator may include training on key words, or on the identification of key words in question, that may trigger the identification of certain types of databases. The query generator may further be capable of reviewing, debugging and optimizing the queries that it generates prior to sending the query to the LLM 4. In some implementations, the response controller 5 may review the query generator's results and approve when the query may be passed along to the LLM 4. Thust the response controller may handle the review and debugging of the generated query and prompt the query generator to revise or optimize the query. In such implementations the response controller 5 may prompt the query generator to perform each portion of the task, for example, the response controller 5 to “identify all database schema relevant to <question>” and subsequently provide the identified schema to the query generator 3 with the instruction to “generate a query that answers <question>”, where <question> is the text question provided by the user. In other implementations the query generator may be programmed to identify the database schema and query all at once as part of the same step. The query evaluator 2 and query generator 3 may be separate models/modules within the system or may be a single model/module trained or programmed to handle both tasks.

The LLM 4 may process the query provided by the query generator 3 to generate a response. Using the schema and the query provided by the query generator 3, the LLM may run those queries and generate a response, which may be presented directly to the user, or as shown in FIG. 1, to a response controller 5. If the response to the user's question is a table of data, the LLM may offer to provide same as a csv, JSON or other suitable file, or may present the user with a graph, or generate a multimedia file that can assist a human user in visualizing the results. In some implementations, the response controller may handle formatting and/or presentation of the results to the users.

The response control 5 may receive a proposed response from the LLM 4 and evaluate whether the response is appropriate or an error. For example, if the response generated by the LLM 4 using the query generated by the query generator 3 is an error message, the response control 5 may feed that error message back to either the query generator (to create a new query to pass along to the LLM 4) or to the LLM so that the LLM's can determine what the error was in its use of the query and correct fore same. The response control 5 may continue this loop of providing error information to the LLM 4 and/or query generator 3, until it receives a suitable response from the LLM 4. In some implementations the LLM may be trained to error correct or debug the query internally without prompting from the response control. In some implementations the response control 5 and/or LLM 4 may be trained or programmed with other debugging and/or optimization methodologies to improve the generated query. Upon receiving a suitable response, the response control 5 may then pass the response along to a display to be presented to the user and, where the result is a table, may generate a graph to help the user visualize the response. The response control 5 may be an AI system or a non-AI system, as the needs of the implementation require.

The database library may be the set of databases that the system has access to that may be queried in order to answer user questions. In some implementations, the database library may consist solely of a discrete set of internal databases. In other implementations the database library may include external databases. An implementation could include one or more of internal databases, any or all databases that are publicly accessible on the internet, as well as paid external database services or subscriptions. Any collected data that may be made available to a system may be included in a database library 6 within the scope of the disclosed concepts.

In one implementation medical patient history system may include a database library 6 having a patient demographic and medical history database, a patient visit/treatment/outcome database and a global or generalized patient demographic and treatment/outcome database. In such an implementation a doctor or nurse may interact with the system through a chat bot user interface-either by typing or by using known speech recognition algorithms—the chat-bot user interface may display the question that the user is asking for verification or may simply provide that question to the query evaluator 2 to begin processes described in the disclosed concepts. Such system might be used to quickly gather information about a patient that is in for a visit (including questions such as “When was <Patient's> last visit?” or “Does <Patient> have any allergies?”), to evaluate the effectiveness of a treatment (“How have <Patient's> <Medical test> results varied after treatment with <medication> began?”) or to evaluate treatment options (“How have <Demographic factor> patients having <sickness> responded to treatment with <medication>?”).

The system 1 in such an implementation would pass the questions like these along to the query evaluator, that should determine that these are questions that can be answered by a database query, and should pass the question along to the query generator 3. The query generator 3 should identify the appropriate databases to be utilized to answer the question, generate a query for same and pass the identified databases' schemas and the query to the LLM 4. The LLM then runs the query, and either displays the result, or in response controller 5 implementations passes the response to the response controller 5, which determines whether to display it to the user (with or without a graph), or to pass it back to the query generator 3 or LLM 4 for error correction.

In some implementations, the query evaluator 2, query generator 3, and LLM 4, or any combination thereof, may be integrated into a single model/module. In some implementations the integrated model/module may recursively iterate through its output until the results are ready to be displayed or presented to the user. In some implementations, a controller, such as the response control 5 may prompt the integrated model/module to iterate through its output until the results are ready to be displayed or presented to the user. For example, in such implementations a response control may first ask the integrated model/module “can <Question> be answered with a database query,” where <Question> is a user question. If the answer is “no” the response control may direct the integrated model/module to answer the question. If the answer is “yes” the response control may then instruct the integrated module to “identify the databases that may be queried to answer <Question> and obtain their database schema.” Once that is done the response control may prompt the integrated module to “Generate a query to answer <Question>” from there the response control may proceed as discussed above with respect to the LLM 4.

FIG. 2 illustrates a flow chart 20 for the query evaluator 20. The query evaluator 2 receives input from the user 21 usually in the form of a question. As described above the query evaluator processes the input received to determine whether a database query is needed to answer the question 22. If so, the input (the user's question) is passed to the query generator 23. If not, the input is passed to the LLM 24, which will generate a response in the ordinary course of its operations.

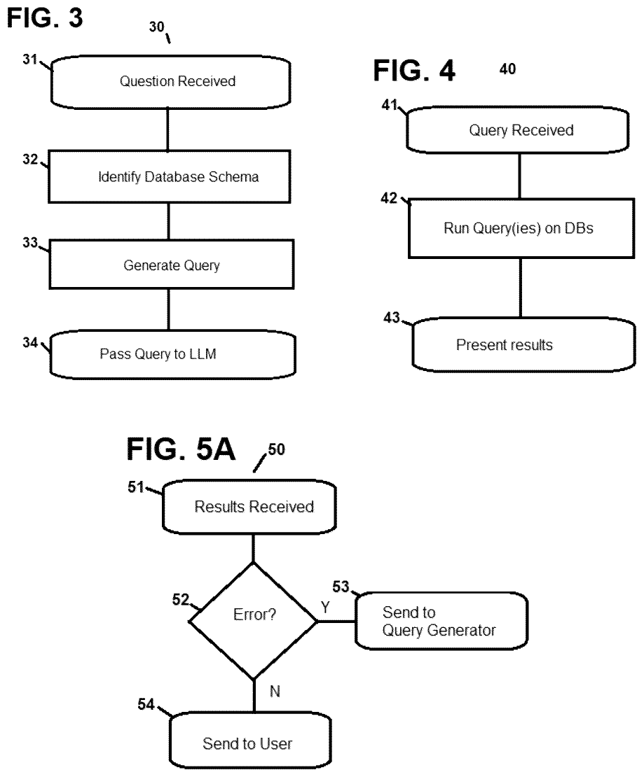

FIG. 3 illustrates a flow chart for the query generator 30. The query generator 3 receives a question that requires a database query 31 from the query evaluator 2. This query is then processed to identify the query schema 32 needed to answer the question, and to generate the database query or queries 33. These may be done as discrete processes or as a single process. The query generator then passes the query output-both the query and the identified database schema—to the LLM for processing 34. As discussed above, the response controller 5 or another separate controller may prompt the query generator to accomplish each of these tasks.

FIG. 4 illustrates a flow chart for the LLM 40, which receives a query output 41 from the query generator 3, and runs the query (or queries) contained therein on the identified databases 42 using the database schema, and generates results which it presents to a user or to a response controller 43.

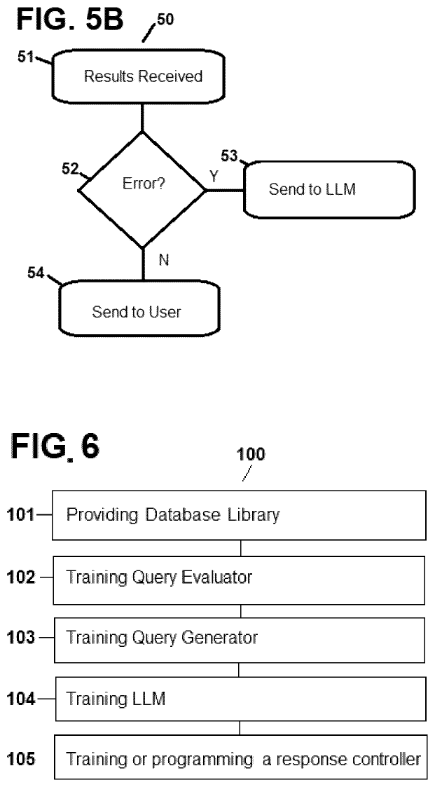

FIGS. 5A & 5B illustrate a flow chart for a response control 50. The response control 5 receives query results from the LLM 51. It then evaluates whether the results are an error or not 52. If so, the response control in FIG. 5A sends the error to the query generator 53 to generate a new query output, while the response control in FIG. 5B sends the error to the LLM 53 to generate a new result using the error information.

FIG. 6 illustrates a method for training a system to respond to questions that require database queries 100 that may include providing a database library 101, training or programming the query evaluator 102, training or programming the query generator 103, training the LLM 104, and training or programming a response controller 105. Providing a database library 101 may include installing a database software or connecting to an existing database on a server or via the internet, or in any other way known in the art or to be developed. As discussed above the databases in the database library can be any collection of data, whether a fully functioning database or a text file or CSV file or any other suitable dataset. Training or programming the query evaluator 102 may include using any of the training methods and/or training algorithms discussed above to teach the query evaluator 2 how to identify when a user question is of the type that can be answered by a database query. Alternatively a query evaluator may be programmed without the need for training same. Training or programming the query generator 103, may include using any of the training methods and/or training algorithms discussed above to teach the query generator how to identify the databases needed to answer the question and generate a query output, including the database schema and the query or queries to be run on the identified databases. Training the LLM 104 may include using any of the training methods and/or training algorithms discussed above to teach the LLM 4 how to process a query output from the query generator 3, including running one or more queries on the identified databases to formulate a response to the question. Training or programming a response controller may include using any of the training methods and/or algorithms discussed above to teach the response controller how to identify errors in proposed responses and where to send them. Alternatively, the response controller can be programmed to do same without training. Any of the features, models/modules or training methods discussed above may be included and/or used in method 100 within the scope of these disclosed concepts.

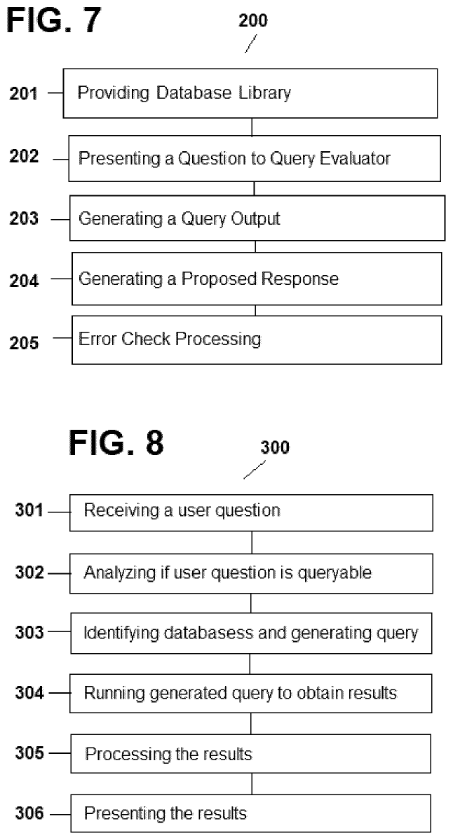

FIG. 7 illustrates a method for using a system to respond to questions that require database queries 200, that may include providing a database library 201, presenting a question to the query evaluator 202, generating a query output 203, generating a proposed response 204, and error check processing 205. Providing a database library 201 may include installing a database software or connecting to an existing database on a server or via the internet, or in any other way known in the art or to be developed, as discussed above re providing a database library 101. Presenting a question to the query evaluator 202 includes putting the system into use so that a user can ask questions of the system. A question asked by the user may be presented to the query evaluator that then determines whether a question requires a database query, as discussed above. Generating a query output 203 occurs when the query evaluator 2 determines that a question from a user can be answered by using a database query and passes the question to the query generator 3. The query generator then identifies the relevant databases from the database library 6, and generates a query that can answer the question, as discussed above. Generating a proposed response 204 occurs when the LLM 4 receives a query output from the query generator3. The LLM then processes the query, including running any necessary queries on the identified databases and generating a proposed response that can be sent to a response controller. Error check processing 205 is performed by the response controller 5, who evaluates a proposed response from the LLM 4. When the response controller determines the proposed response contains an error, it will cycle the proposed response to either the query generator 3 (to generate a new query) or to the LLM 4 (to use the error to correct its processing of the query to generate a revised proposed response), depending on the implementation. Any of the features, models/modules or training methods discussed above may be included and/or used in method 100 within the scope of these disclosed concepts.

FIG. 8 illustrates a method for intelligent question analysis, query generation, and optimization 300, that may include: receiving a user question 301; analyzing whether the question is queryable 302; if so, identifying databases and generating a query to answer the question 303; running the generated query to obtain results 304; processing the results 305; and presenting the results 306. Receiving a user question 301 may involve making the system accessible to a human user who can ask a question using any of the input methods described above, such as voice or text input. Analyzing whether a question is queryable 302 may involve analyzing the user question with a query evaluator 2, such as using a small AI model to determine if the user question can be addressed using a database query. Analyzing whether a question is queryable 302 may be performed by a small AI model, such as natural language processing models, deep learning models, and LLMs with reduced parameters. Any of the query evaluators 2 discussed above may be used with method 300 in accordance with the disclosed concepts. Identifying databases and generating a query to answer the question 303 may involve using a query generator 3 to evaluate whether the user question can be addressed using an internal database or if it requires external data sources, identify which databases should be queried to answer the user question; generating a query based on the user question. Identifying which databases should be queried to answer the user question includes keyword triggers to facilitate the identification of database queries. Where internal and external data sources are required to answer a question, method 300 may further include integration of internal and external data sources, which may involve querying public datasets and web-based information sources and/or generating a combined database having internal and external data. Generating the query may involve generating code in one or more programming languages or query languages. Generating the query may also involve using a code optimization process or techniques such as refactoring, code simplification, or resource optimization. Running the generated code to obtain results 304 may involve providing as input the generated query, including any applicable database schema for identified databases to an LLM 4 for processing to generate results. Processing the results 305 may involve using a response control 5 to iteratively cycle the results to either the LLM 4 or the query generator 4 to generate revised results, or training the LLM to recursively error check and debug results until they are ready for presentation. Processing the results 305 may include detecting errors within the generated code autonomously; and debugging and optimizing the generated code for performance. Presenting the results 306 may include converting the results into human-readable formats, exporting them into graphical/multimedia formats that can be easily interpreted by users, or presenting the results in a file format for download or saving. Presenting the results 306 may involve generating graphical/multimedia formats that include, but are not limited to, images, charts, graphs, interactive visualizations, or videos.

A system for implementing the method 300, may include a query evaluator 2, a database identification module, a query generation module, a LLM 4 and a multimedia representation module. The database identification module and the query generation module may be combined as a query generator 3. Any of the query evaluator 2, query generator 3 (i.e. database identification module and query generation module), and LLM may be combined into an integrated model/module. The system may also include an error checking module such as a response control 5. The error checking module and multimedia representation module may be combined as a response control 5. These modules may interact with each other to process user queries and generate optimized code and easily interpretable results.

In some implementations a non-transitory, computer-readable medium may contain instructions that when executed by the processor cause the processor to perform any of the methods described herein.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

I claim:

1. A system for responding to questions that require database queries comprising:
a query evaluator trained or programmed to be capable of receiving a user input question and evaluating whether the question requires one or more database queries to answer;
a query generator trained or programmed to be capable of processing the question in order to identify at least one database from a library of databases may be queried to answer the question, and to generate a query output comprising a database schema for the at least one identified database and a query to be run on the identified databases;
a large language model trained to be capable of receiving the query output from the query generator, to run the query on the identified databases, and to generate a response.

2. The system of claim 1, further comprising a response controller trained or programmed to be capable of receiving the response from the large language model, evaluating whether it is an error, and in the case of an error providing the error to the query generator to be used in generating a revised query output, until it receives a non-error response.

3. The system of claim 1, further comprising a response controller trained or programmed to be capable of receiving the response from the large language model, evaluating whether it is an error, and in the case of an error providing the error to the large language model to be used in generating a revised response, until it receives a non-error response.

4. The system of claim 1, wherein the query evaluator and the query generator are an integrated model or module.

5. The system of claim 1, wherein the results are displayed as a graph or multimedia file to assist the user in visualizing the data.

6. The system of claim 1, wherein the results are exported as a data file that may be downloaded or saved by the user.

7. The system of claim 1 wherein the query evaluator, the query generator and the LLM are integrated into a single model or module.

8. The system of claim 7 wherein the integrated model or module recursively iterates through its output until the response is ready to be displayed or presented to the user.

9. The system of claim 7 further comprising a response control which prompts the integrated model or module to iterate through its output until the response is ready to be displayed or presented to the user.

10. A method for training a system to respond to questions that require database queries comprising:
providing a database library;
training or programming a query evaluator to be capable of determining whether an input question can be answered using a database query;
training or programming a query generator to be capable of identifying which databases in the database library are relevant to answering the input question, and generating a query to answer same; and
training a large language model to be capable of receiving a query output from the query generator, the query output comprising at least one database schema for identified databases and at least one query.

11. The method of claim 10, further comprising training or programming a response controller to be capable of identifying errors in a proposed response from the large language model and sending same to the query generator to generate a revised query.

12. The method of claim 10, further comprising training or programming a response controller to be capable of identifying errors in a proposed response from the large language model and sending same to the large language model to use the error information to process a revised proposed response.

13. The method of claim 10, wherein the query evaluator and the query generator are an integrated model or module.

14. The method of claim 10, wherein the results are displayed as a graph or multimedia file to assist the user in visualizing the data.

15. The method of claim 10, wherein the results are exported as a data file that may be downloaded or saved by the user.

16. The method of claim 10 wherein the query evaluator, the query generator and the LLM are integrated into a single model or module.

17. The method of claim 16 wherein the integrated model or module recursively iterates through its output until the response is ready to be displayed or presented to the user.

18. The method of claim 16 further comprising a response control which prompts the integrated model or module to iterate through its output until the response is ready to be displayed or presented to the user.

19. A method for querying a large language model comprising:
providing database library;
presenting a question to the query evaluator, such that the query evaluator can determine whether the question can be answered by running a database query;
when the question presented can be answered by running a database query, providing the question to a query generator, to process the question and to (i) identify at least one database in the database library that can be queried to answer the question, and (ii) generate a query output;
providing the query output to a large language model trained to receive and process the query output and to generate a proposed response to the question using results from running a query in the query output.

20. The method of claim 19, further comprising providing the proposed response from the large language model to a response controller that evaluates whether the proposed response has errors, and when the proposed response has errors sends the error to the query generator to be used to generate a revised query output.

21. The method of claim 19, further comprising providing the proposed response from the large language model to a response controller that evaluates whether the proposed response has errors, and when the proposed response has errors sends the error to the large language model to be used to generate a revised proposed response.

22. The method of claim 19, wherein the query evaluator and the query generator are an integrated model or module.

23. The method of claim 19, wherein the results are displayed as a graph or multimedia file to assist the user in visualizing the data.

24. The method of claim 19, wherein the results are exported as a data file that may be downloaded or saved by the user.

25. The method of claim 19 wherein the query evaluator, the query generator and the LLM are integrated into a single model or module.

26. The method of claim 25 wherein the integrated model or module recursively iterates through its output until the response is ready to be displayed or presented to the user.

27. The method of claim 25 further comprising a response control which prompts the integrated model or module to iterate through its output until the response is ready to be displayed or presented to the user.

28. A method for intelligent question analysis, query generation, and optimization, comprising:
receiving a user question;
analyzing the user question to determine if the user question can be addressed using a database query;
if so, identifying which databases should be queried to answer the user question;
generating a query to answer the question;
running the generated query on a large language model to obtain results; and
converting the results into human-readable formats or exporting them into graphical/multimedia formats that can be easily interpreted by users.

29. The method of claim 28 further comprising:
detecting errors within the generated query autonomously; and
debugging and optimizing the generated query.

30. The method of claim 28, wherein the analyzing the user question is performed by a small AI model is selected from a group consisting of natural language processing models, deep learning models, and LLMs with reduced parameters.

31. The method of claim 28 wherein the identifying which databases should be queried to answer the user question comprises evaluating whether the user question can be addressed using an internal database or if it requires external data sources.

32. The method of claim 28, wherein the identifying which databases should be queried to answer the user question includes keyword triggers to facilitate the identification of database queries.

33. The method of 31, further comprising integration of internal and external data sources comprising querying public datasets and/or web-based information sources.

34. The method of claim 28, wherein the generating a query comprises generating code in various programming languages.

35. The method of claim 29, wherein the debugging and optimizing the generated query involves techniques such as refactoring, code simplification, or resource optimization.

36. The method of claim 28, wherein the graphical/multimedia formats include, images, charts, graphs, interactive visualizations, or videos.

37. A system for implementing the method of claim 28, comprising a query analysis module, a database identification module, a code generation module, and a multimedia representation module.

38. The system of claim 37, wherein the query analysis module, database identification module, code generation module, and multimedia representation module communicate and interact with each other to process user queries and generate optimized code and easily interpretable results.
